(19) United States
(12) Patent Application Publication
(10) Pub. No.: US 2026/0130480 A1
(43) Pub. Date: May 14, 2026

(54) KNIFE ROLL

(71) Applicant: Eldritch Labs, LLC, Houston, TX (US)

(72) Inventor: Gabriel Antony Boyko, Richmond, TX (US)

(73) Assignee: Eldritch Labs, LLC, Houston, TX (US)

(21) Appl. No.: 19/389,374

(22) Filed: Nov. 14, 2025

Related U.S. Application Data
(60) Provisional application No. 63/720,515, filed on Nov. 14, 2024.

(51) Int. Cl. A45C 11/26; A45C 13/02; A45C 13/10; B26B 29/02

(52) U.S. Cl. CPC A45C 11/26; A45C 13/02; A45C 13/10; B26B 29/025; A45C 2013/1015

(57) ABSTRACT

An improved, user-customizable knife roll with enhanced safety features. The knife roll is modular, allowing users to selectively secure various individually sheathed knives, configured uniquely to their needs. The backing layer, preferably made of durable canvas or leather, contains one or more rows of evenly spaced connectors, such as metal snaps or other fasteners on the interior. These fasteners accommodate individually sheathed knives or other kitchen tools, each with a number of corresponding fasteners based on their dimensions. The standardized sheaths are provided in various sizes to fit different culinary knife types, such as from small paring knives to large cleavers. This ensures each knife has a secure and appropriately sized sheath. The sheath fasteners securely hold the knives, allowing the user to arrange and transport them as desired.

### CROSS-REFERENCE TO RELATED APPLICATIONS

This application claims priority to and the benefit of U.S. Provisional Application No. 63/720,515, filed Nov. 14, 2024, the entire contents of which are herein incorporated by reference in their entirety.

### BACKGROUND

### Field of the Invention

This invention generally relates to a container for storing and transporting tools and more particularly a tool roll for storing and transporting knives and other kitchen tools.

### Description of Related Art

Individuals often have a need to store and transport a number of tools in a convenient but secure and safe manner. One conventional method of doing this is the use of a tool roll. A tool roll is typically made of a flexible backing material, such as leather or canvas, with pockets along the bottom into which the various tools can be inserted. After the tools are inserted into the pockets, the tool roll can be rolled up with the backing material on the exterior. There can be a tie or other fastener to allow the user to secure the tool roll in a closed position. A significant drawback to known tool rolls is that the pockets are of a fixed size. This may be fine when the tool roll is designed for a specific set of tools, but it can become a problem when the user wants to add or customize the set of tools in the tool roll.

One particular use case is the need for a chef or cook to store and transport their culinary knives and related kitchen tools. Individuals working in the kitchen at a restaurant often will bring in their own personal set of knives to use at work. Even individuals at home may have a set of culinary knives that the desire to safely store their culinary knives and be able to conveniently take them out when cooking. Conventional knife rolls have predetermined shallow pockets along the bottom of the backing material in which the knife handles are inserted. This results in the blades being exposed, which can cause injury when the user reaches into the knife roll to remove one of the knives. The exposed blades are also subject to being dulled from contact with other knives. Having the pockets sized to hold the handles of the knives also can lead to the knife not being adequately secured, especially for larger knives, leading to the knives slipping out of the pouch.

In addition, the pockets in traditional knife rolls are fixed in place and vary in size based on the knife it is intended to accommodate. As a result, a roll may not accommodate all of a user's knives and yet may have unused pouches going to waste. For example, a butcher may need to house multiple cleavers and large slicers on a daily basis and thus would need a larger number of large pockets and fewer smaller pockets. In contrast, a pastry chef may need several garnishing tools and smaller knives secured and thus would not need many (if any) larger pockets but would need more smaller pockets. Alternatively, a single user may have a larger set of culinary knives and want to be able to customize the particular knives that are included in the knife roll depending on the particular activity that is planned. Even if a particular knife roll had the right number of pockets it the sizes required by a particular user, it may not have the sized pockets in the user's preferred location in the tool roll.

Therefore, there is a need for an improved modular knife roll for storing and transporting knives, particularly culinary knives, and other culinary tools.

### BRIEF DESCRIPTION OF THE INVENTION

The invention is an improved, user-customizable knife roll with enhanced safety features. The knife roll is modular, allowing users to selectively secure various individually sheathed knives, configured uniquely to their needs. The backing layer, preferably made of durable canvas or leather, contains one or more rows of evenly spaced connectors, such as metal snaps, loops of fabric, or other fasteners on the interior. These fasteners accommodate individually sheathed knives or other kitchen tools, each with a number of corresponding fasteners, such as snaps or straps that fasten around the fabric loops, based on their dimensions. The standardized sheaths are provided in various sizes to fit different culinary knife types, such as from small paring knives to large cleavers. This ensures each knife has a secure and appropriately sized sheath. The sheath fasteners securely hold the knives, allowing the user to arrange and transport them as desired.

### BRIEF DESCRIPTION OF FIGURES

For a more complete understanding of the present invention and for further advantages thereof, reference is now made to the following description taken in conjunction with the accompanying drawings in which:

FIG. 1 is a perspective view of a preferred embodiment of the knife roll;

FIG. 2 is a side view of the knife roll depicted in FIG. 1 in a partially closed position;

FIG. 3 is a side view of the knife roll depicted in FIG. 1 in a nearly closed position;

FIG. 4 is a perspective view of the knife roll depicted in FIG. 1 in a closed position;

FIG. 5 depicts a plurality of knives and associated sheaths used in the knife roll depicted in FIG. 1;

FIG. 6 is a top view of the knife roll depicted in FIG. 1 with a plurality of knives oriented in a first position;

FIG. 7 is a top view of the knife roll depicted in FIG. 6 with the same plurality of knives oriented in a second position;

FIG. 8 is a perspective view of a second preferred embodiment of the knife roll;

FIG. 9 is a side view of the knife roll depicted in FIG. 8 in a partially closed position;

FIG. 10 is a side view of the knife roll depicted in FIG. 8 in a nearly closed position;

FIG. 11 is a perspective view of the knife roll depicted in FIG. 8 in a closed position;

FIG. 12 depicts a plurality of knives and associated sheaths used in the knife roll depicted in FIG. 8;

FIG. 13 is a top view of the knife roll depicted in FIG. 8 with a plurality of knives oriented in a first position; and

FIG. 14 is a top view of the knife roll depicted in FIG. 13 with the same plurality of knives oriented in a second position.

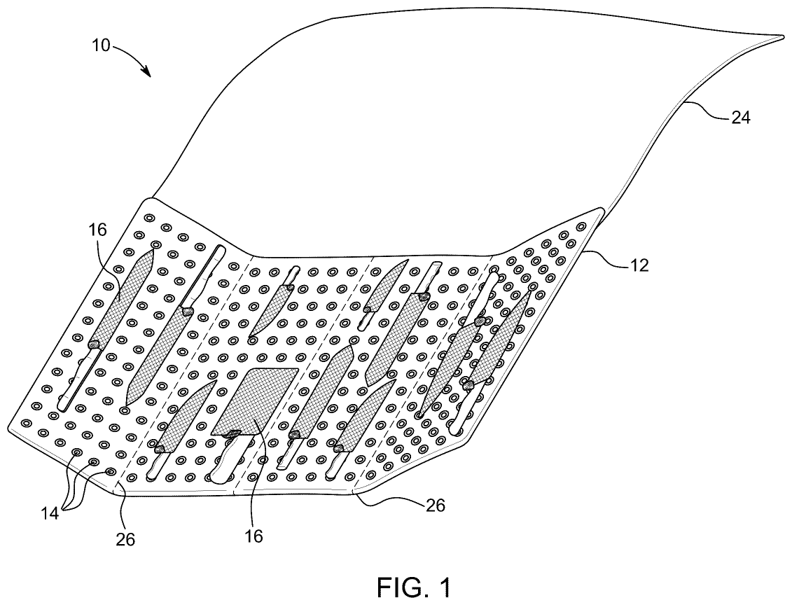

### DESCRIPTION OF THE PREFERRED EMBODIMENTS

These and further aspects, features and advantages of the invention become apparent to the skilled person from a study of the following detailed description of the preferred embodiments and claims. The examples contained herein are intended to merely describe and illustrate the invention, but not to limit it, and in particular, the invention is not limited to such examples. Each feature from one aspect or embodiment of the invention may also be used in any other aspect or embodiment of the invention. The use of the term “about” is intended to encompass all values that lie within the range of the respective measurement accuracy known to the skilled person.

A preferred embodiment of the invention, is depicted in the figures in which the knife roll 10 is formed of a generally rectangular backing 12. Backing 12 is preferably formed of canvas or canvas-like material, but can be made of other sturdy flexible materials such as leather. In some embodiments, the backing 12 may be made of a waterproof material, such as for use by fishermen and sportsmen. The interior surface of the backing 12, has one or more rows of fasteners along the length of the backing 12, such as snaps 14. Snaps 14 are regularly spaced from each other and preferably the rows of snaps 14 have the same spacing as between snaps 14 in each row.

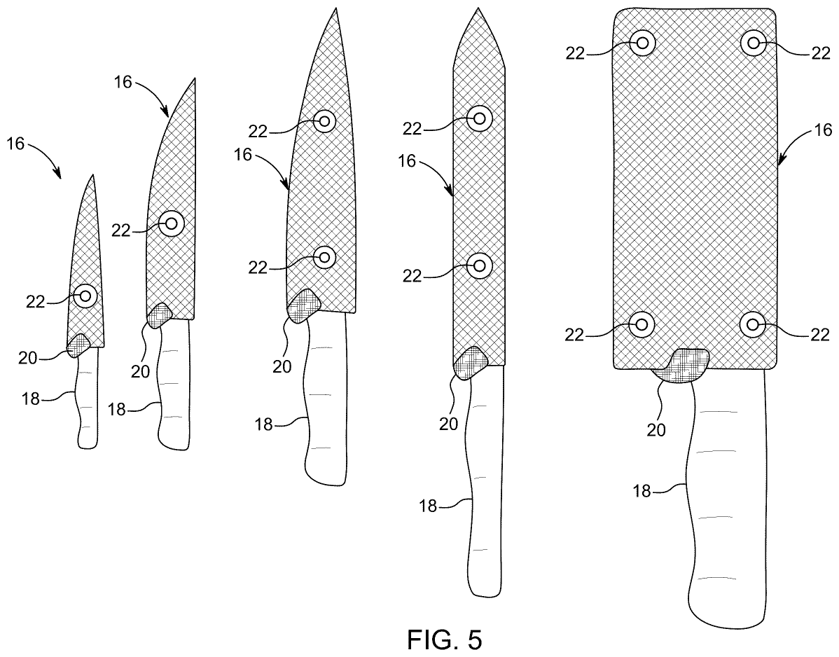

A number of knife sheaths 16, as more particularly shown in FIG. 5, are provided. Each sheath 16 is sized and shaped based upon the blade of the specific knife 18 that it is intended to hold. Sheath 16 can be made of the same material as backing 12. Alternatively, it can be made of any other material that is tough enough that the knife blade will not cut through it so that it can adequately secure and protect the blade of the knife. Examples of materials that can be used for the sheath 16 include leather, canvas, and plastic. Each sheath 16 preferably has strap 20 that helps prevent the knife 18 from unintentionally sliding out of sheath 16. Strap 20 may be made from a variety of materials, including but not limited to elastic, vinyl or leather. Strap 20 can also be a hook and loop material that can be secured on the material of sheath 16 itself or a corresponding strip of hook and loop material attached to sheath 16. Depending upon the size and shape of the knife 18 that a particular sheath 16 is designed to hold, one or more fasteners, such as snaps 22 are attached to one side of sheath 16. Where there are multiple snaps 22 on a single sheath 16, they are positioned and spaced from each other to match the spacing of snaps 14 on backing 12. When a sheath 16 contains a single snap 22, it is preferably located on the sheath 16 such that the likelihood of knife 18 interfering with other knives 18 in other sheaths 16 is minimized.

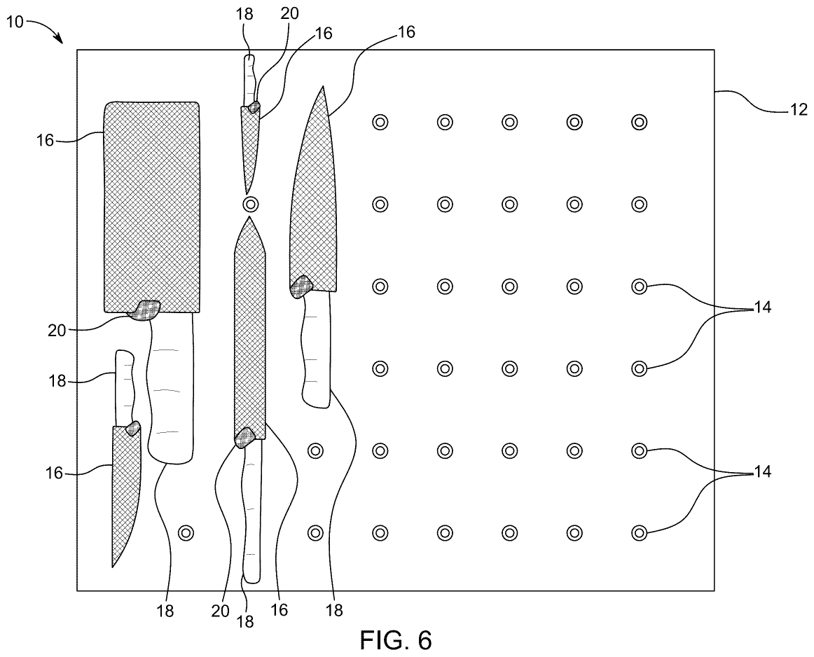

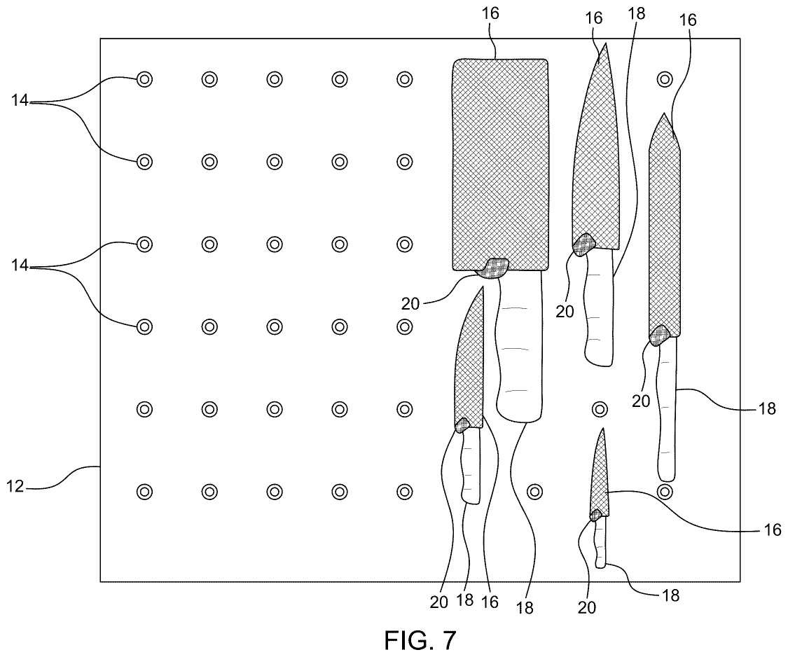

As shown more particularly in FIGS. 6 and 7, each sheath 16 can be secured to the backing 12 of knife roll 10 at the desired location by connection of the one or more snaps 22 on sheath 16 to the one or more corresponding snaps 14 on backer 12. Larger knives 18 would occupy multiple snaps 14 on the backing 12 (although it may not be attached to all of them), while smaller knives 18 would only occupy a single snap 14. This allows the users to customize the roll for the specific knives they have as well as organize them in the desired order, while keeping the blade edges protected in the sheath. They also can quickly change the knives that are stored in the roll or their configuration depending upon the particular activity or event, all while keeping the knife edges safely sheathed.

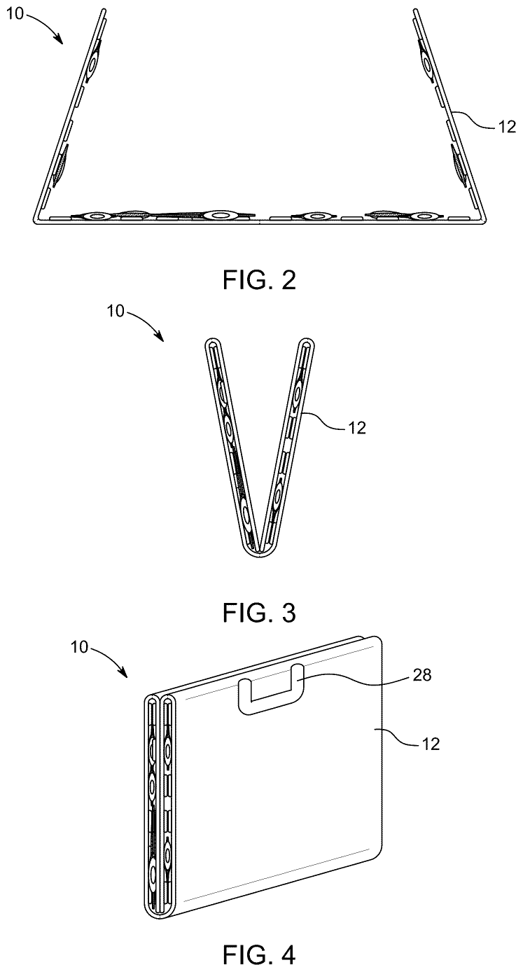

Knife roll 10 also preferably has a flap 24 attached to the top of backing 12. Flap 24 is preferably made of the same material as backing 12. Flap 24 can fold down over the knives 18 in their respective sheaths 16 to provide further protection for the knives 18. Backing 12 may then be rolled up so the knife roll 10 can be more compactly stored and transported. Alternatively, backing 12 may have pre-defined fold lines or creases 26 to aid in rolling or folding up the knife roll 10. Creases 26 are particularly helpful when backing 12 is thicker or made of a stiffer material. As shown in FIGS. 2 and 3, the outer portions of backing 12 can be folded into the middle along the outer creases 26 and then the two sides folded up along the middle crease 26 to make the knife roll 10 compact and easy to transport and store. Additional fasteners, such as snaps or hook and loop fasteners, can be used to secure the knife roll 10 in the closed position. Alternatively, one or more cords (not shown) can be secured to the outside of the backing 12 and tied together to hold the knife roll 10 in the closed position. Optionally, handles 28 can be provided on the outside of backing 12 to help when transporting the knife roll 10.

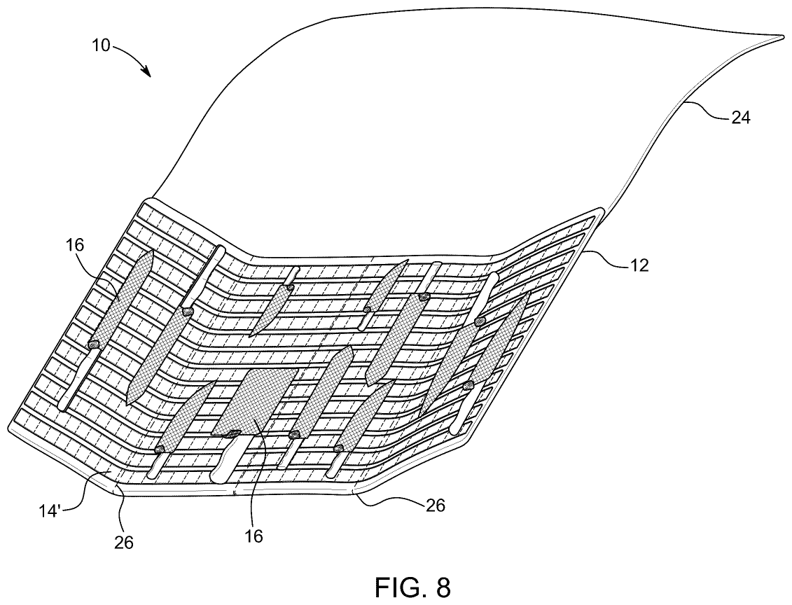

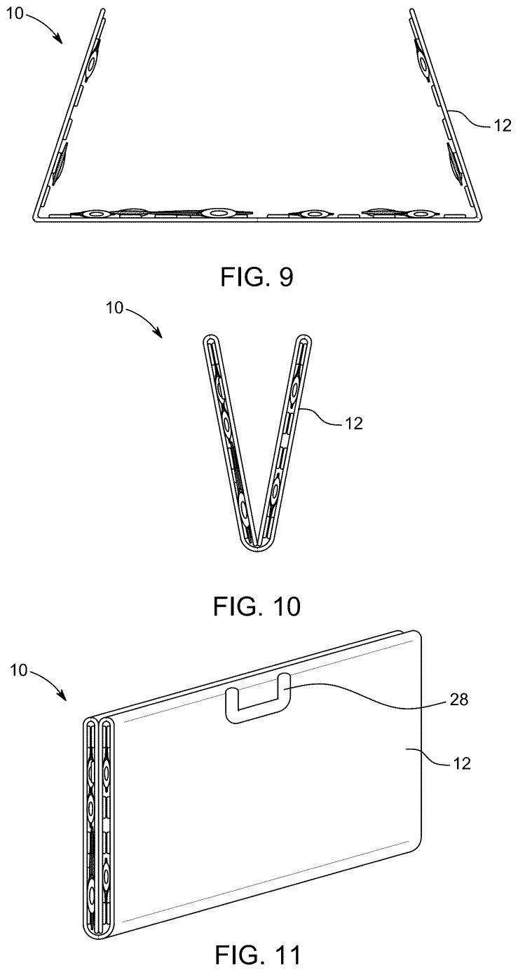

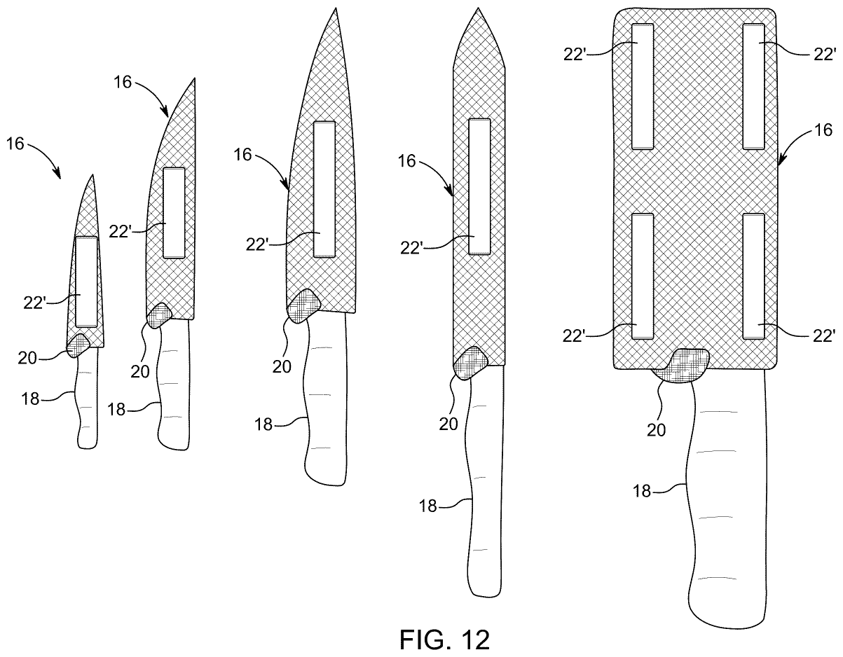

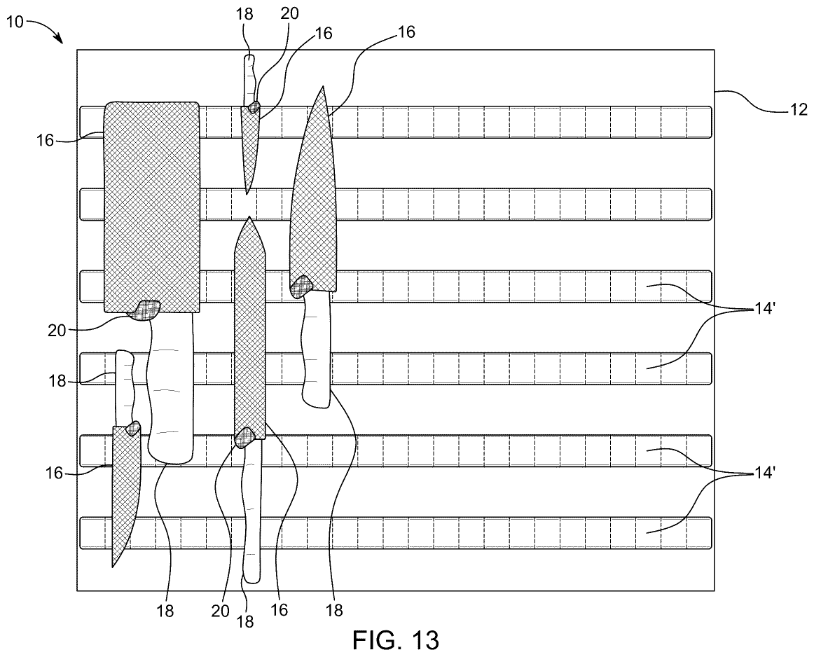

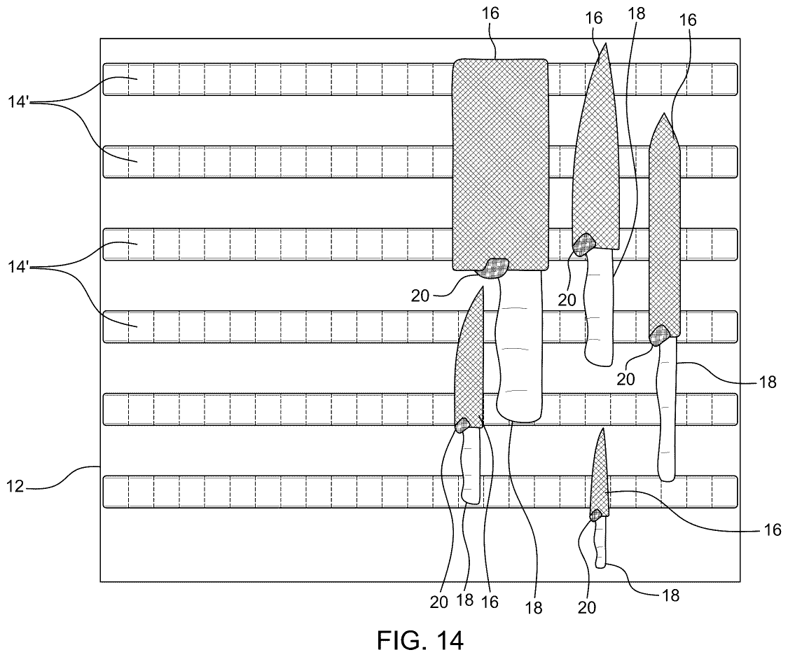

A second preferred embodiment of the invention is depicted in FIGS. 8-14. This embodiment uses different types of fasteners from the first embodiment. Rather than snaps 14, this preferred embodiment uses a series of fabric loops 14′ that are attached to backing 12. This can be a strip of tactical fabric with a periodic line of stitching securing the fabric to the backing 12 to form the loops 14′. As more particularly shown in FIG. 12, instead of snaps 22 on the back of the sheaths 16, this embodiment uses straps 22'. Straps 22′ are preferably permanently attached to sheath 16 at one end. The other end of strap 22′ can be selectively attached back to the sheath 16. This allows the strap 22′ to be fed behind one of the loops 14′ on the backing 12 and secured back to sheath 16, thereby securing sheath 16 in place on the backing 12. As in the first embodiment, there larger sheaths 16 can have multiple straps 22′ so as to better secure larger knives 18 in place on backing 12.

The preferred knife roll 10 thereby provides a high degree of configurability and enhanced safety. Users can customize the arrangement of their knives 18, creating a setup that meets their specific needs and preferences. Additionally, the secure sheath 16 securely holds knife 18 in place, thereby significantly reducing the risk of knives 18 becoming loose or falling out during transport. Importantly, the design of sheath 16 ensures that knife blades are fully covered, helping to both prevent users from cutting themselves on exposed edges during storage and transport and preventing the exposed blades from being dulled due to contact with other knives 18 during storage and transit. This feature greatly enhances user safety, making the knife roll a safer and more practical choice for culinary professionals and enthusiasts. The ability to reconfigure the knife roll for different sets of knives allows for multiple combinations of knife shapes, styles, and placements, further increasing its versatility and user safety. The inclusion of a variety of sheath sizes further ensures that each knife, regardless of its type or size, is securely and safely stored.

The above descriptions of certain embodiments are made for the purpose of illustration only and are not intended to be limiting in any manner. Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is being claimed is:

1. A knife roll comprising:
a backing layer, having a first and second side and adapted to be rolled or folded up such that the second side forms an exterior of the knife roll;
a plurality of fasteners having a first configuration and arranged in a pattern on the first side of the backing layer;
a plurality of sheaths;
wherein each of the plurality of sheaths:
is sized and shaped to hold and secure a blade of a knife;
comprises one or more fasteners on a back of the sheath, wherein the fasteners each have a second configuration that is adapted to connect to the first configuration and are arranged in the pattern.
wherein each of the plurality of sheaths can be selectively positioned on the first side of the backing layer and secured by connecting the fasteners with the second configuration on the sheath to the fasteners having the first configuration on the backing layer.

2. The knife roll of claim 1, wherein the plurality of fasteners on the backing layer are a plurality of flexible loops.

3. The knife roll of claim 2, wherein the one or more fasteners on the back of the plurality of sheaths are straps adapted to be secured through at least one of the plurality of flexible loops on the backing layer.

4. The knife roll of claim 3, wherein the one or more straps are permanently secured to the sheath at a first end and selectively secured to the sheath at a second end.

5. The knife roll of claim 1, wherein the plurality of sheaths further comprises a strap adapted to limit the knife sliding out of the sheath.

6. The knife roll of claim 1, wherein the backing layer comprises a flexible material.

7. The knife roll of claim 6, wherein the backing material is made from a material selected from the group consisting of leather, canvas and fabric.

8. The knife roll of claim 1, wherein the plurality of sheaths are made from a material selected from leather, canvas and plastic.

9. The knife roll of claim 1 wherein the plurality of fasteners on the backing layer are a first side of a snap.

10. The knife roll of claim 9, wherein the one or more fasteners on the back of the plurality of sheaths are a second side of the snap adapted to be secured to the first side of the snap on the backing layer.

11. The knife roll of claim 1, wherein the plurality of fasteners on the backing layer are a first side of a hook and loop fastener and the one or more fasteners on the back of the plurality of sheaths are a second side of the hook and loop fastener.
